(19) United States
(12) Patent Application Publication
(10) Pub. No.: US 2019/0050514 A1
(43) Pub. Date: Feb. 14, 2019

(54) FAULT INJECTION USING HYBRID SIMULATION MODEL

(71) Applicant: Intel Corporation, Santa Clara, CA (US)

(72) Inventors: Massimo Ceppi, Santa Clara, CA (US); Teo Cupaiuolo, Santa Clara, CA (US); Mauro Pipponzi, Santa Clara, CA (US); Kevin Locker, Scottsdale, AZ (US)

(73) Assignee: Intel Corporation, Santa Clara, CA (US)

(21) Appl. No.: 16/021,181

(22) Filed: Jun. 28, 2018

(51) Int. Cl. G06F 17/50

(52) U.S. Cl. CPC G06F 17/5022; G06F 17/505

(57) ABSTRACT

A method to perform a hybrid Register Transfer Level (RTL)/gate-level (GL) fault injection simulation of a hardware design comprises generating a list of one or more fault nodes in a GL netlist for the hardware design, mapping functionally equivalent comparison points between RTL logic for the hardware design and GL netlist of the hardware design, identifying a nearest set of downstream comparison points for one or more logic paths for the one or more fault nodes, identifying a nearest set of upstream comparison points for the one or more identified downstream comparison points, replacing RTL logic with equivalent GL netlist logic to provide hybrid RTL/GL netlist in code, and performing fault injection simulating using the hybrid RTL/GL netlist code

### FIELD

The present disclosure generally relates to the field of electronics. More particularly, an embodiment relates to fault injection simulation systems.

### BACKGROUND

The primary abstraction level for writing tests that verify a logic design is the Register Transfer Level (RTL). Fault injection requires these tests to be run at the Gate Level (GL) of abstraction where physical hardware faults are typically modelled. To bridge from higher RTL abstraction, where tests are written, to the lower abstraction of a GL netlist design, where fault simulations are performed, considerable effort must be spent creating a GL simulation environment capable of running these tests.

Existing solutions attempt to automate the task of creating a GL simulation environment rather than trying to eliminate it. While certain subtasks have been automated, no generic solution that addresses the wide range of RTL and GL synthesis flows has yet been found. While automation-based solutions may be useful, considerable effort is still being spent developing, validating and maintaining these automated solutions.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 is a diagram of an example fault injection simulation environment in accordance with one or more embodiments.

FIG. 2 is a diagram of a substitutable logic cloud for a fault node and correlated inputs and outputs in accordance with one or more embodiments.

FIG. 3 is a diagram of example RT and GL Netlist with compare points in accordance with one or more embodiments.

FIG. 4 is a diagram of a method to replace RTL logic with equivalent GL Netlist logic to perform a hybrid RTL/GL Netlist simulation in accordance with one or more embodiments.

FIG. 5 illustrates a block diagram of a system on chip (SOC) package in accordance with an embodiment.

FIG. 6 is a block diagram of a processing system according to an embodiment.

FIG. 7 is a block diagram of a processor having one or more processor cores, an integrated memory controller, and an integrated graphics processor in accordance with one or more embodiments.

FIG. 8 is a block diagram of a graphics processor, which may be a discrete graphics processing unit, or may be a graphics processor integrated with a plurality of processing cores in accordance with one or more embodiments.

FIG. 9 is a generalized diagram of a machine learning software stack in accordance with one or more embodiments.

FIG. 10 illustrates training and deployment of a deep neural network in accordance with one or more embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

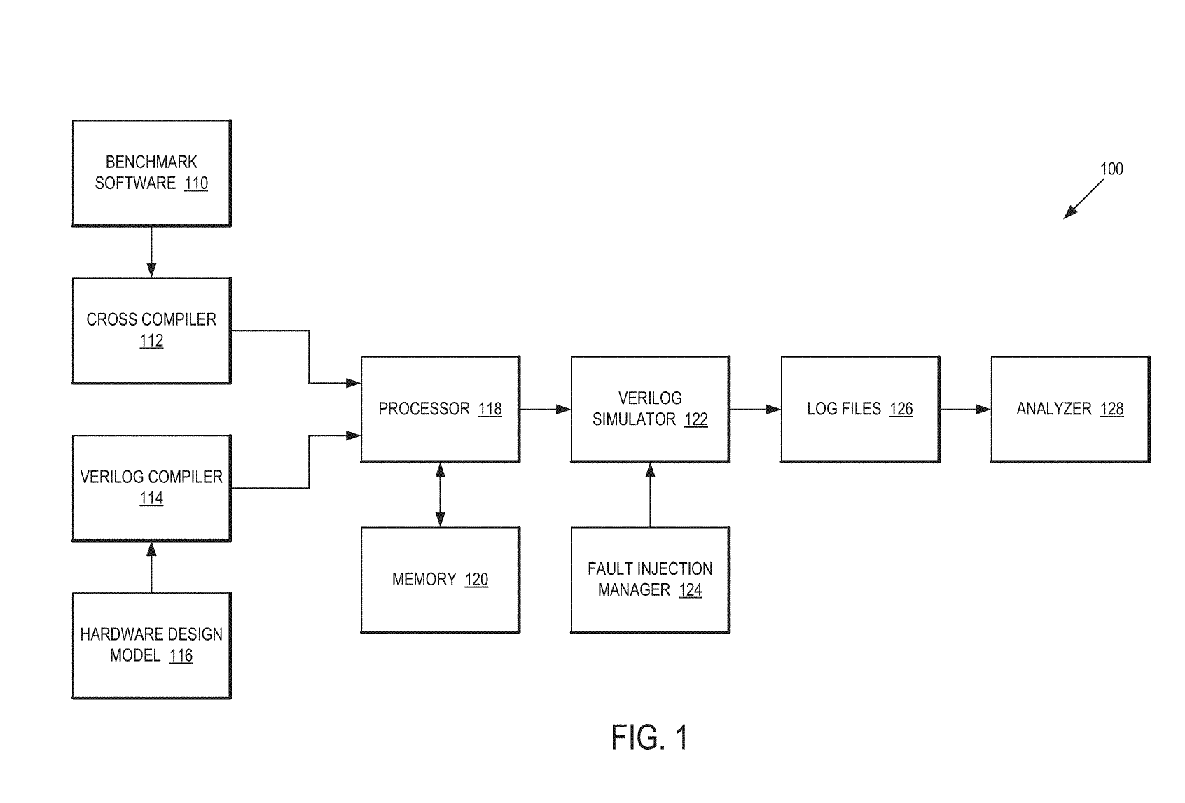

Referring now to FIG. 1, a diagram of an example fault injection simulation environment in accordance with one or more embodiments will be discussed. FIG. 1 illustrates a fault injection simulation system 100 using Verilog, a hardware design language (HDL) to implement register transfer level (RTL) fault injection simulation and analysis. Although system 100 illustrates a Verilog system, other types of HDL languages may be utilized, and the scope of the claimed subject matter is not limited in this respect. Furthermore, although system 100 is shown for purposes of examples, system 100 may include more or fewer blocks than shown and/or with the blocks in various other arrangements, and the scope of the claimed subject matter is not limited in this respect.

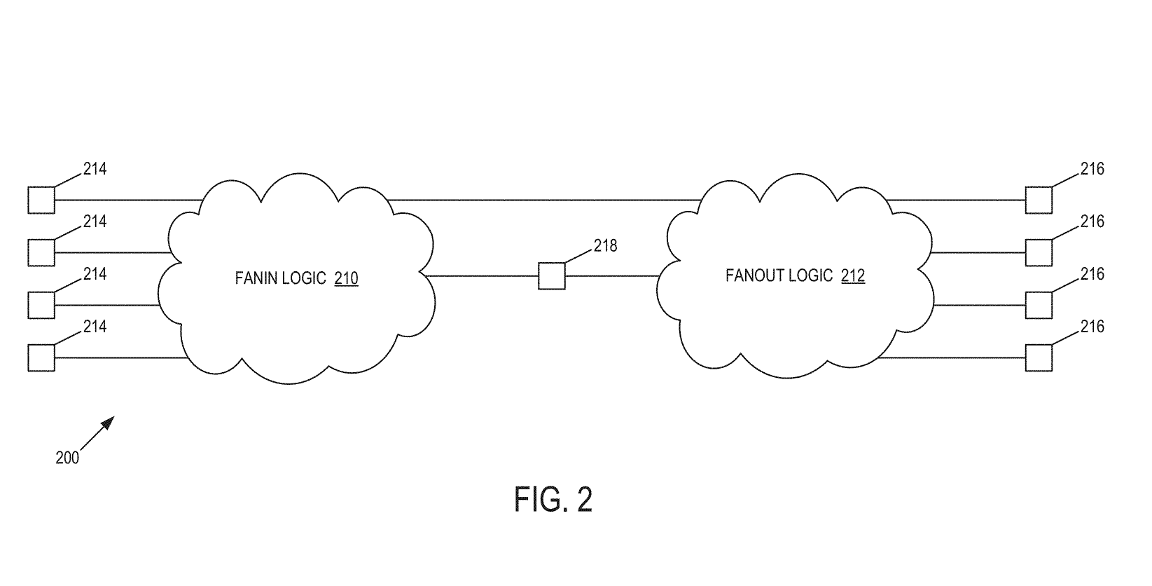

System 100 may include benchmark software 110 compiled by cross compiler 112, and a hardware design model 118 compiled by a Verilog compiler 114. The compiler outputs are fed into a processor 118 coupled to a memory 120 in order to execute a Verilog based simulator 122 on the RTL logic being simulated. Fault injection analysis of the RTL logic may be controlled by a fault injection manager 124 to result in one or more log files 126 for the fault injection simulation. The log files 126 may be processed by an analyzer 128 for evaluation of the fault injection simulation. Since fault injection often involves a comprehensive set of tests running in Gate Level (GL) simulation environments using GL netlist-based simulation, the system 100 of may be modified to replace at least some of the RTL logic with GL netlist logic for one or more fault nodes so that the testing of the fault nodes in the simulation may be performed using GL netlist logic using the RTL context. A diagram of a substitutable logic cloud to replace the RTL logic with such GL netlist logic is shown in and described with respect to FIG. 2, below.

Referring now to FIG. 2, a diagram of a minimum substitutable logic cloud for a fault node and correlated inputs and outputs in accordance with one or more embodiments will be discussed. A logic design represented by different abstraction levels such as RTL logic and GL netlist logic contains corresponding points in each representation that can be proven to be equivalent. Using these equivalent points, we equivalent logic clouds may be found that “encompass” each fault node. By substituting the logic cloud in the RTL logic with its equivalent GL logic cloud, the effect of each fault injected can be accurately simulated in the RTL context.

As shown in FIG. 2, a comprehensive list of all fault nodes found in the GL netlist, for example fault node 218, may be generated. Logic Equivalency Checking (LEC) of the like may then be used to map all functionally equivalent comparison points (CPs) between the RTL design and an equivalent GL netlist. This can be captured in a one-to-one (1:1) or one-to-many (1:M) correlation database. For each GL fault node, traverse the fan-out logic network 212 may be traversed to identify the nearest set of downstream CPs for each logic path, for example downstream Fanout CPs 216. For each identified fanout CP 216, the fan-in logic cloud may be traversed to identify the nearest set of upstream CPs, for example Fanin CPs 214. The fan-in CPs 214 and the fan-out CPs 216 may then be correlated with RTL logic. The result of these operations will be a set of fan-out nodes and fan-in nodes that define the end points of a GL netlist logic cloud that contains all the logic influenced by the selected fault node 218 and directly corresponds with an equivalent RTL logic cloud bounded by the same nodes. By selectively replacing the RTL logic cloud with some logical representation of the corresponding GL netlist cloud, the effect of the GL fault node 218 can be simulated within the RTL context.

The minimum logic cloud may comprise strictly combinatorial logic, excluding any flip-flops (FFs) or state elements, which minimizes the potential for RTL functional simulation problems due to the timing related issues in the substituted GL logic. There are several possible methods for replacing RTL logic with equivalent GL logic which will depend on the specific implementation. In embodiment, the GL logic may be substituted directly including the fault node. In another embodiment, the GL logic may be reduced into equivalent Boolean expressions or a Truth Table that still provides access to the fault node. A third embodiment comprises a combination of the first embodiment and the second embodiment. In a fourth embodiment, a separate version of the GL logic or equivalent Boolean representation or combination may be created that includes the Boolean effect of a fault type, for example separate logic for stuck-at-0 and stuck-at-1 faults.

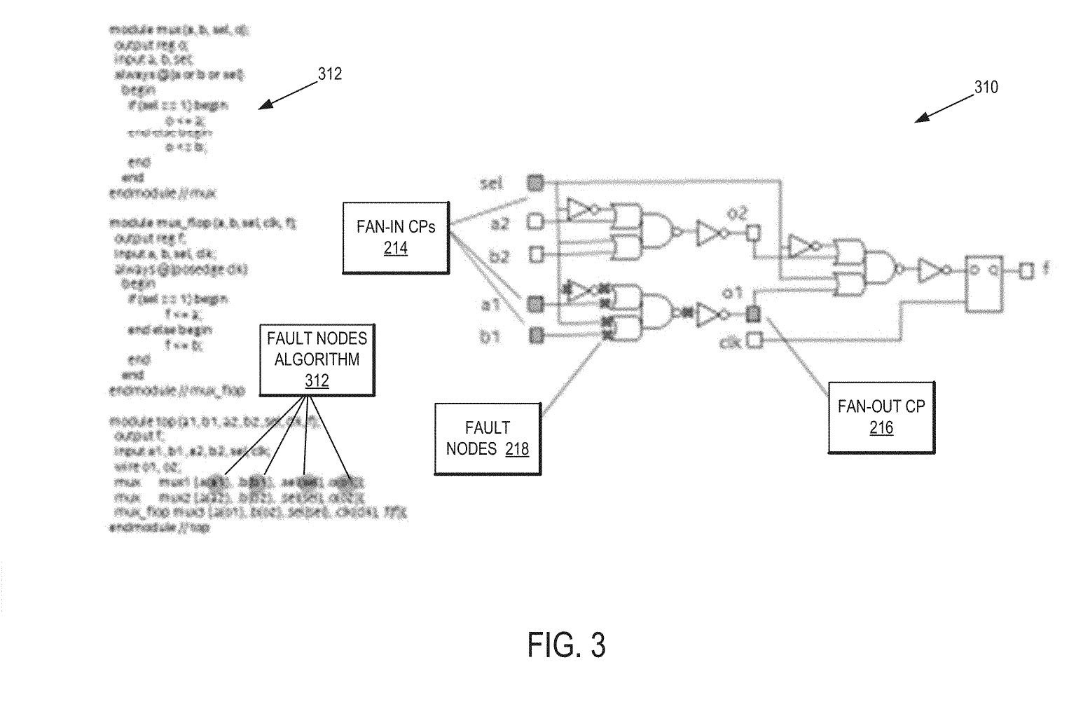

Referring now to FIG. 3, a diagram of example RT and GL Netlist with compare points in accordance with one or more embodiments will be discussed. In FIG. 3, an example of GL netlist logic 310 includes one or more fault nodes 218, fan-out compare point 216, and fan-in compare points 214. The RTL logic 312 includes code or algorithms 312 for one or more of the fault nodes in the GL netlist logic. A method to replace the GL netlist logic 310 that encompasses one or more fault nodes 218 with fault nodes code or algorithms 314 is shown in and described

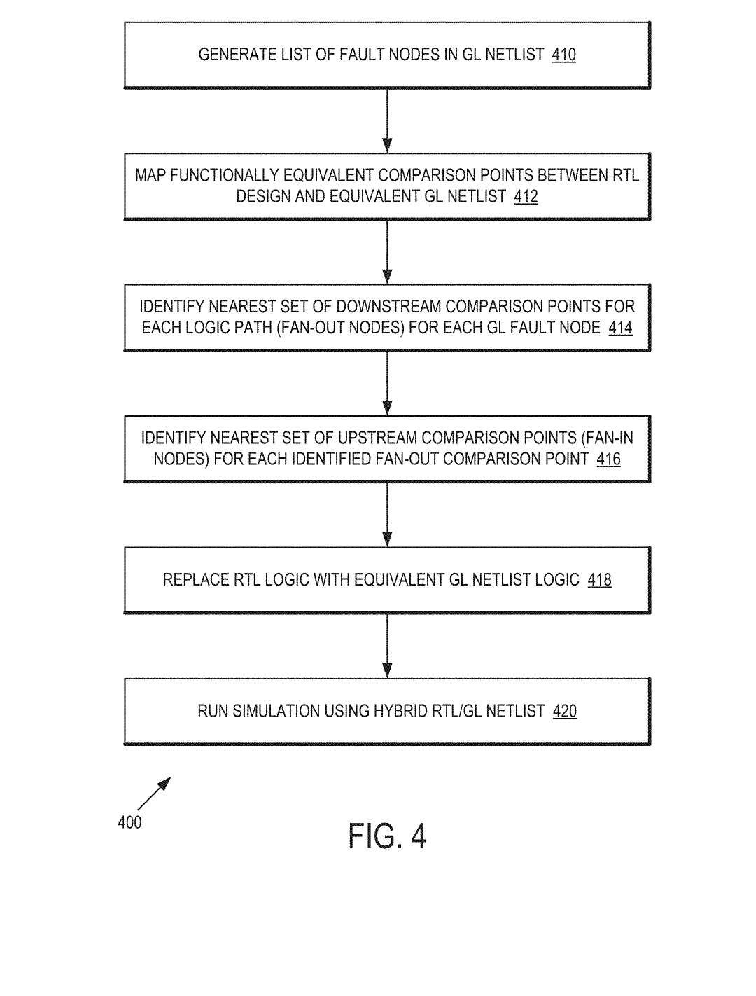

Referring now to FIG. 4, a diagram of a method to replace RTL logic with equivalent GL Netlist logic to perform a hybrid RTL/GL Netlist simulation in accordance with one or more embodiments will be discussed. Although FIG. 4 shows one particular method 400, it should be known that the method 400 may include more or few operations than shown and/or in various other orders, and the scope of the claimed subject matter is not limited in these respects. At operation 410, a list of the fault nodes in GL netlist may be generated. The functionally equivalent comparison points between RTL design the equivalent GL netlist may be mapped at operation 412. At operation 414, a nearest set of downstream comparison points (fan-out nodes) may be identified for each logic path for each GL fault node. At operation 416, a nearest set of upstream comparison points (fan-in nodes) may be identified for each identified fan-out comparison point. At operation 418, RTL logic may be replaced with the equivalent GL netlist logic. The simulation may then be run using the hybrid RTL/GL netlist model at operation 420.

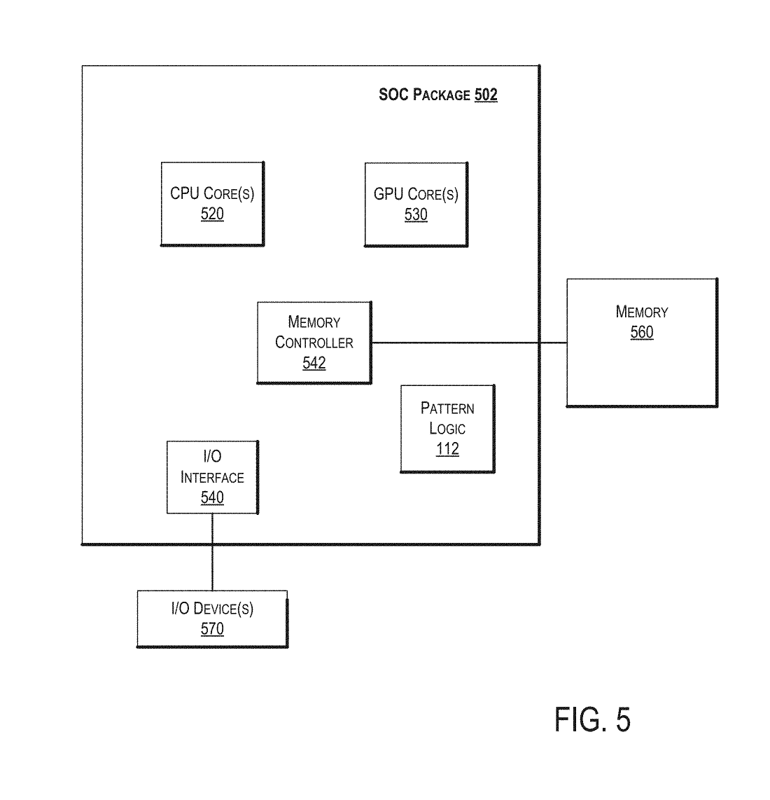

FIG. 5 illustrates a block diagram of a system on chip (SOC) package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 via the memory controller 542. In an embodiment, the memory 660 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like.

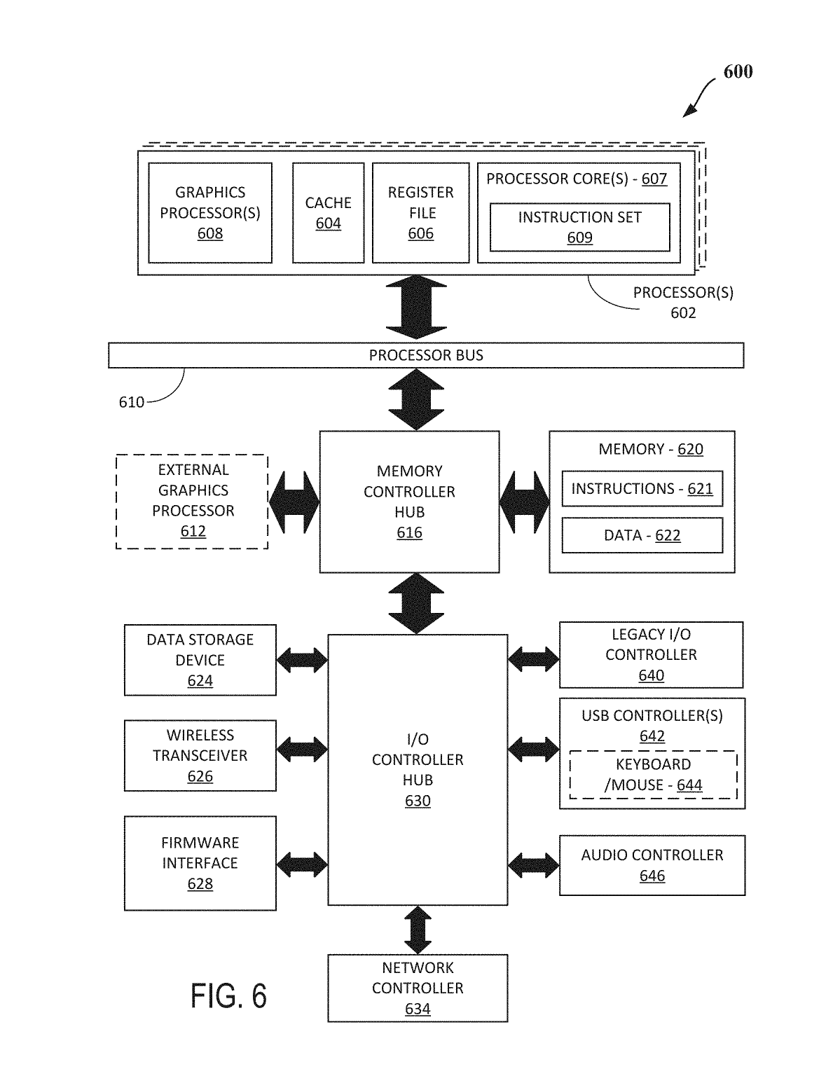

FIG. 6 is a block diagram of a processing system 600, according to an embodiment. In various embodiments the system 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include or be incorporated within a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 609. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 702 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, processor 602 is coupled to a processor bus 610 to transmit communication signals such as address, data, or control signals between processor 602 and other components in system 600. In one embodiment the system 600 uses an exemplary “hub” system architecture, including a memory controller hub 616 and an Input Output (I/O) controller hub 630. A memory controller hub 616 facilitates communication between a memory device and other components of system 600, while an I/O Controller Hub (ICH) 630 provides connections to I/O devices via a local I/O bus. In one embodiment, the logic of the memory controller hub 616 is integrated within the processor.

Memory device 620 can be a dynamic random-access memory (DRAM) device, a static random-access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 executes an application or process. Memory controller hub 616 also couples with an optional external graphics processor 612, which may communicate with the one or more graphics processors 608 in processors 602 to perform graphics and media operations.

In some embodiments, ICH 630 enables peripherals to connect to memory device 620 and processor 602 via a high-speed I/O bus. The I/O peripherals include, but are not limited to, an audio controller 646, a firmware interface 628, a wireless transceiver 626 (e.g., Wi-Fi, Bluetooth), a data storage device 624 (e.g., hard disk drive, flash memory, etc.), and a legacy I/O controller 640 for coupling legacy (e.g., Personal System 2 (PS/2)) devices to the system. One or more Universal Serial Bus (USB) controllers 642 connect input devices, such as keyboard and mouse 644 combinations. A network controller 634 may also couple to ICH 630. In some embodiments, a high-performance network controller (not shown) couples to processor bus 610. It will be appreciated that the system 600 shown is exemplary and not limiting, as other types of data processing systems that are differently configured may also be used. For example, the I/O controller hub 630 may be integrated within the one or more processor 602, or the memory controller hub 616 and I/O controller hub 630 may be integrated into a discreet external graphics processor, such as the external graphics processor 612.

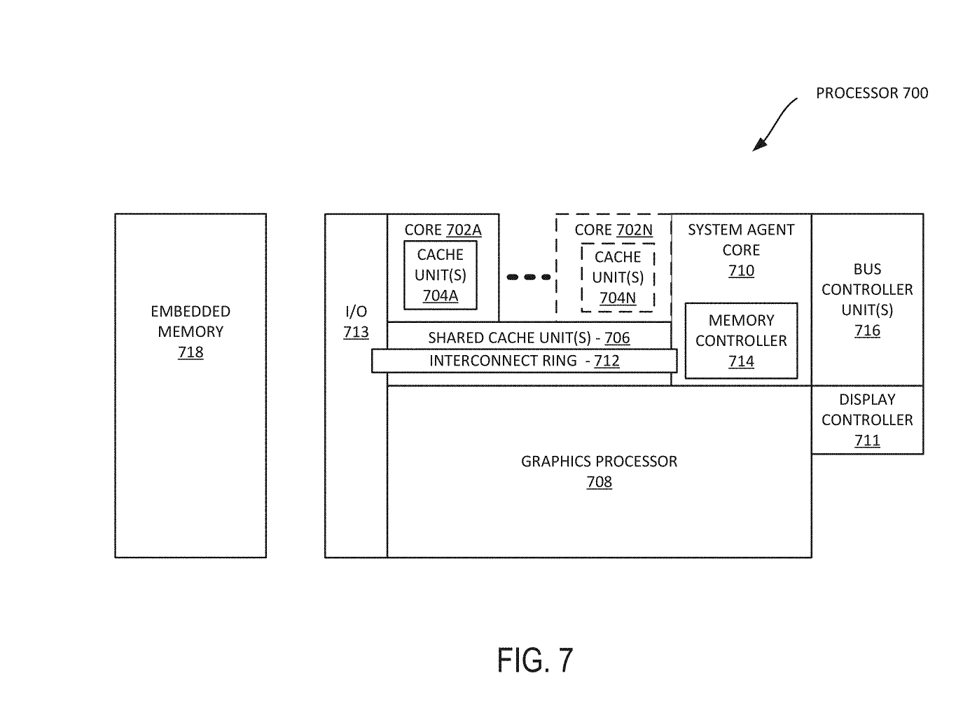

FIG. 7 is a block diagram of an embodiment of a processor 700 having one or more processor cores 702A to 702N, an integrated memory controller 714, and an integrated graphics processor 708. Those elements of FIG. 7 having the same reference numbers (or names) as the elements of any other figure herein can operate or function in any manner similar to that described elsewhere herein but are not limited to such. Processor 700 can include additional cores up to and including additional core 702N represented by the dashed lined boxes. Each of processor cores 702A to 702N includes one or more internal cache units 704A to 704N. In some embodiments each processor core also has access to one or more shared cached units 706.

The internal cache units 704A to 704N and shared cache units 706 represent a cache memory hierarchy within the processor 700. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 706 and 704A to 704N.

In some embodiments, processor 700 may also include a set of one or more bus controller units 716 and a system agent core 710. The one or more bus controller units 716 manage a set of peripheral buses, such as one or more Peripheral Component Interconnect buses (e.g., PCI, PCI Express). System agent core 710 provides management functionality for the various processor components. In some embodiments, system agent core 710 includes one or more integrated memory controllers 714 to manage access to various external memory devices (not shown).

In some embodiments, one or more of the processor cores 702A to 702N include support for simultaneous multi-threading. In such embodiment, the system agent core 710 includes components for coordinating and operating cores 702A to 702N during multi-threaded processing. System agent core 710 may additionally include a power control unit (PCU), which includes logic and components to regulate the power state of processor cores 702A to 702N and graphics processor 708.

In some embodiments, processor 700 additionally includes graphics processor 708 to execute graphics processing operations. In some embodiments, the graphics processor 708 couples with the set of shared cache units 706, and the system agent core 710, including the one or more integrated memory controllers 714. In some embodiments, a display controller 711 is coupled with the graphics processor 708 to drive graphics processor output to one or more coupled displays. In some embodiments, display controller 711 may be a separate module coupled with the graphics processor via at least one interconnect or may be integrated within the graphics processor 708 or system agent core 710.

In some embodiments, a ring-based interconnect unit 712 is used to couple the internal components of the processor 700. However, an alternative interconnect unit may be used, such as a point-to-point interconnect, a switched interconnect, or other techniques, including techniques well known in the art. In some embodiments, graphics processor 708 couples with the ring interconnect 712 via an I/O link 713.

The exemplary I/O link 713 represents at least one of multiple varieties of I/O interconnects, including an on package I/O interconnect which facilitates communication between various processor components and a high-performance embedded memory module 718, such as an eDRAM (or embedded DRAM) module. In some embodiments, each of the processor cores 702 to 702N and graphics processor 808 use embedded memory modules 718 as a shared Last Level Cache.

In some embodiments, processor cores 702A to 702N are homogenous cores executing the same instruction set architecture. In another embodiment, processor cores 702A to 702N are heterogeneous in terms of instruction set architecture (ISA), where one or more of processor cores 702A to 702N execute a first instruction set, while at least one of the other cores executes a subset of the first instruction set or a different instruction set. In one embodiment processor cores 702A to 702N are heterogeneous in terms of microarchitecture, where one or more cores having a relatively higher power consumption couple with one or more power cores having a lower power consumption. Additionally, processor 700 can be implemented on one or more chips or as an SoC integrated circuit having the illustrated components, in addition to other components.

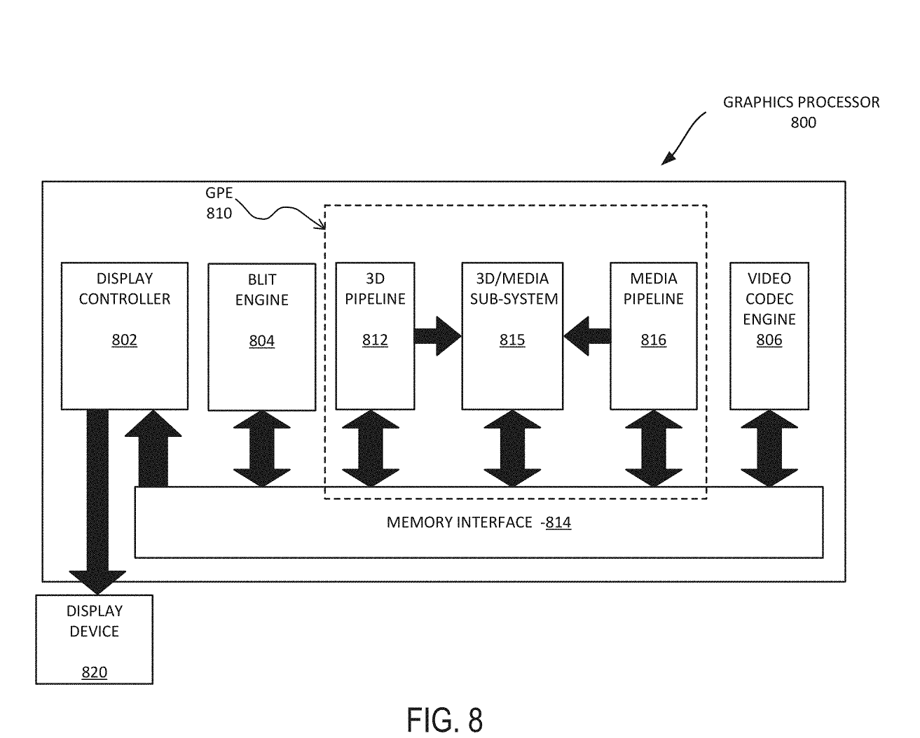

FIG. 8 is a block diagram of a graphics processor 800, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 800 includes a memory interface 814 to access memory. Memory interface 814 can be an interface to local memory, one or more internal caches, one or more shared external caches, and/or to system memory.

In some embodiments, graphics processor 800 also includes a display controller 802 to drive display output data to a display device 820. Display controller 802 includes hardware for one or more overlay planes for the display and composition of multiple layers of video or user interface elements. In some embodiments, graphics processor 800 includes a video codec engine 806 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 800 includes a block image transfer (BLIT) engine 804 to perform two-dimensional (2D) rasterizer operations including, for example, bit-boundary block transfers. However, in one embodiment, 2D graphics operations are performed using one or more components of graphics processing engine (GPE) 810. In some embodiments, graphics processing engine 810 is a compute engine for performing graphics operations, including three-dimensional (3D) graphics operations and media operations.

In some embodiments, GPE 810 includes a 3D pipeline 812 for performing 3D operations, such as rendering three-dimensional images and scenes using processing functions that act upon 3D primitive shapes (e.g., rectangle, triangle, etc.). The 3D pipeline 812 includes programmable and fixed function elements that perform various tasks within the element and/or spawn execution threads to a 3D/Media sub-system 815. While 3D pipeline 812 can be used to perform media operations, an embodiment of GPE 810 also includes a media pipeline 816 that is specifically used to perform media operations, such as video post-processing and image enhancement.

In some embodiments, media pipeline 816 includes fixed function or programmable logic units to perform one or more specialized media operations, such as video decode acceleration, video de-interlacing, and video encode acceleration in place of, or on behalf of video codec engine 806. In some embodiments, media pipeline 816 additionally includes a thread spawning unit to spawn threads for execution on 3D/Media sub-system 815. The spawned threads perform computations for the media operations on one or more graphics execution units included in 3D/Media sub-system 815.

In some embodiments, 3D/Media subsystem 815 includes logic for executing threads spawned by 3D pipeline 812 and media pipeline 816. In one embodiment, the pipelines send thread execution requests to 3D/Media subsystem 815, which includes thread dispatch logic for arbitrating and dispatching the various requests to available thread execution resources. The execution resources include an array of graphics execution units to process the 3D and media threads. In some embodiments, 3D/Media subsystem 815 includes one or more internal caches for thread instructions and data. In some embodiments, the subsystem also includes shared memory, including registers and addressable memory, to share data between threads and to store output data.

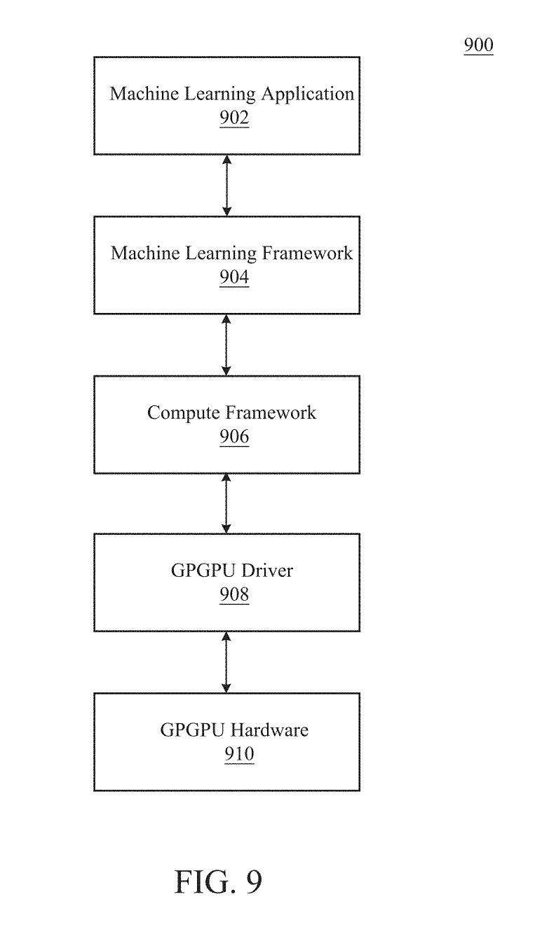

FIG. 9 is a generalized diagram of a machine learning software stack 900. A machine learning application 1102 can be configured to train a neural network using a training dataset or to use a trained deep neural network to implement machine intelligence. The machine learning application 902 can include training and inference functionality for a neural network and/or specialized software that can be used to train a neural network before deployment. The machine learning application 902 can implement any type of machine intelligence including but not limited to image recognition, mapping and localization, autonomous navigation, speech synthesis, medical imaging, or language translation.

Hardware acceleration for the machine learning application 902 can be enabled via a machine learning framework 904. The machine learning framework 904 can provide a library of machine learning primitives. Machine learning primitives are basic operations that are commonly performed by machine learning algorithms. Without the machine learning framework 904, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 904. Exemplary primitives include tensor convolutions, activation functions, and pooling, which are computational operations that are performed while training a convolutional neural network (CNN). The machine learning framework 904 can also provide primitives to implement basic linear algebra subprograms performed by many machine-learning algorithms, such as matrix and vector operations.

The machine learning framework 904 can process input data received from the machine learning application 902 and generate the appropriate input to a compute framework 906. The compute framework 906 can abstract the underlying instructions provided to the GPGPU driver 908 to enable the machine learning framework 904 to take advantage of hardware acceleration via the GPGPU hardware 910 without requiring the machine learning framework 904 to have intimate knowledge of the architecture of the GPGPU hardware 910. Additionally, the compute framework 1106 can enable hardware acceleration for the machine learning framework 904 across a variety of types and generations of the GPGPU hardware 910.

The computing architecture provided by embodiments described herein can be configured to perform the types of parallel processing that is particularly suited for training and deploying neural networks for machine learning. A neural network can be generalized as a network of functions having a graph relationship. As is known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for compute vision and image recognition applications, but they also may be used for other types of pattern recognition such as speech and language processing. The nodes in the CNN input layer are organized into a set of “filters” (feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described herein present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

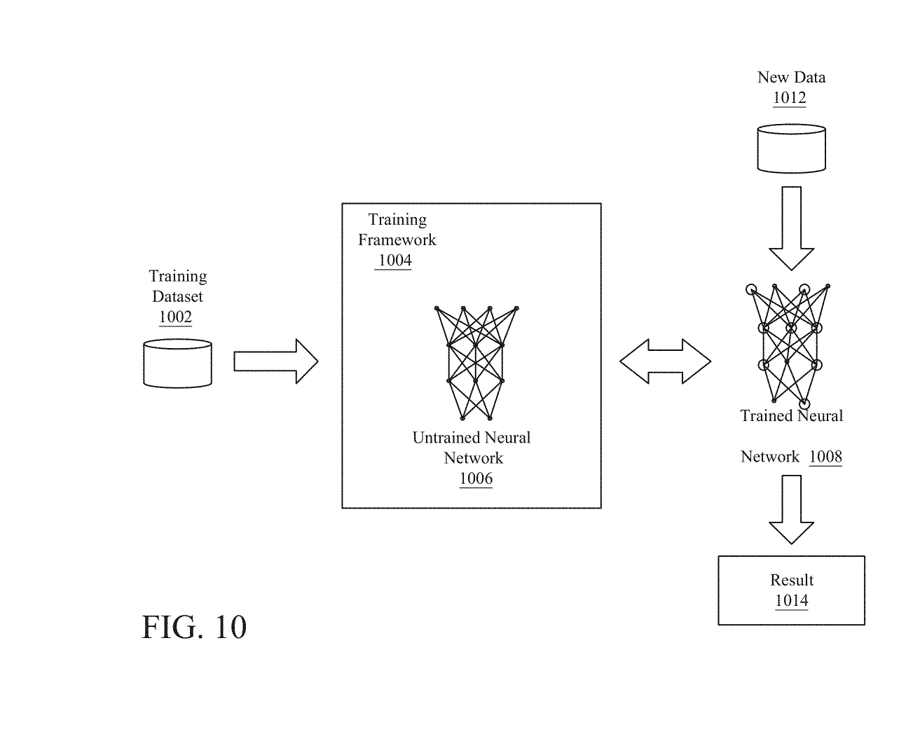

FIG. 10 illustrates training and deployment of a deep neural network. Once a given network has been structured for a task the neural network is trained using a training dataset 1002. Various training frameworks have been developed to enable hardware acceleration of the training process. For example, the machine learning framework 904 of FIG. 9 may be configured as a training framework 1004. The training framework 1004 can hook into an untrained neural network 1006 and enable the untrained neural net to be trained using the parallel processing resources described herein to generate a trained neural network 1008. To start the training process the initial weights may be chosen randomly or by pre-training using a deep belief network. The training cycle then be performed in either a supervised or unsupervised manner.

Supervised learning is a learning method in which training is performed as a mediated operation, such as when the training dataset 1002 includes input paired with the desired output for the input, or where the training dataset includes input having known output and the output of the neural network is manually graded. The network processes the inputs and compares the resulting outputs against a set of expected or desired outputs. Errors are then propagated back through the system. The training framework 1004 can adjust to adjust the weights that control the untrained neural network 1006. The training framework 1004 can provide tools to monitor how well the untrained neural network 1006 is converging towards a model suitable to generating correct answers based on known input data. The training process occurs repeatedly as the weights of the network are adjusted to refine the output generated by the neural network. The training process can continue until the neural network reaches a statistically desired accuracy associated with a trained neural network 1208. The trained neural network 1008 can then be deployed to implement any number of machine learning operations.

Unsupervised learning is a learning method in which the network attempts to train itself using unlabeled data. Thus, for unsupervised learning the training dataset 1002 will include input data without any associated output data. The untrained neural network 1006 can learn groupings within the unlabeled input and can determine how individual inputs are related to the overall dataset. Unsupervised training can be used to generate a self-organizing map, which is a type of trained neural network 1007 capable of performing operations useful in reducing the dimensionality of data. Unsupervised training can also be used to perform anomaly detection, which allows the identification of data points in an input dataset that deviate from the normal patterns of the data.

Variations on supervised and unsupervised training may also be employed. Semi-supervised learning is a technique in which in the training dataset 1002 includes a mix of labeled and unlabeled data of the same distribution. Incremental learning is a variant of supervised learning in which input data is continuously used to further train the model. Incremental learning enables the trained neural network 1008 to adapt to the new data 1012 without forgetting the knowledge instilled within the network during initial training.

Whether supervised or unsupervised, the training process for particularly deep neural networks may be too computationally intensive for a single compute node. Instead of using a single compute node, a distributed network of computational nodes can be used to accelerate the training process.

The following examples pertain to further embodiments. In example one, method to perform a hybrid Register Transfer Level (RTL)/gate-level (GL) fault injection simulation of a hardware design comprises generating a list of one or more fault nodes in a GL netlist for the hardware design, mapping functionally equivalent comparison points between RTL logic for the hardware design and GL netlist of the hardware design, identifying a nearest set of downstream comparison points for one or more logic paths for the one or more fault nodes, identifying a nearest set of upstream comparison points for the one or more identified downstream comparison points, replacing RTL logic with equivalent GL netlist logic to provide hybrid RTL/GL netlist in code, and performing fault injection simulating using the hybrid RTL/GL netlist code. Example two may include the subject matter of example one or any of the examples described herein, wherein the said mapping is performed using logic equivalency checking (LEC). Example three may include the subject matter of example one or any of the examples described herein, wherein a result of said mapping is stored in a one-to-one (1:1) database or a one-to-many (1:M) database. Example four may include the subject matter of example one or any of the examples described herein, wherein the downstream comparison points comprise fan-out nodes. Example five may include the subject matter of example one or any of the examples described herein, wherein the upstream comparison points comprise fan-in nodes. Example six may include the subject matter of example one or any of the examples described herein, wherein the downstream comparison points and the upstream comparison points comprise the equivalent GL netlist logic influenced by the one or more fault nodes and correspond to the RTL logic to be replaced. Example seven may include the subject matter of example one or any of the examples described herein, wherein the RTL logic for the hardware design is implemented using Verilogic.

In example eight, one or more non-transitory machine-readable media have instructions stored thereon that, when executed by a processor to perform a hybrid Register Transfer Level (RTL)/gate-level (GL) fault injection simulation of a hardware design, result in generating a list of one or more fault nodes in a GL netlist for the hardware design, mapping functionally equivalent comparison points between RTL logic for the hardware design and GL netlist of the hardware design, identifying a nearest set of downstream comparison points for one or more logic paths for the one or more fault nodes, identifying a nearest set of upstream comparison points for the one or more identified downstream comparison points, replacing RTL logic with equivalent GL netlist logic to provide hybrid RTL/GL netlist in code, and performing fault injection simulating using the hybrid RTL/GL netlist code. Example nine may include the subject matter of example eight or any of the examples described herein, wherein the said mapping is performed using logic equivalency checking (LEC). Example ten may include the subject matter of example eight or any of the examples described herein, wherein a result of said mapping is stored in a one-to-one (1:1) database or a one-to-many (1:M) database. Example eleven may include the subject matter of example eight or any of the examples described herein, wherein the downstream comparison points comprise fan-out nodes. Example twelve may include the subject matter of example eight or any of the examples described herein, wherein the upstream comparison points comprise fan-in nodes. Example thirteen may include the subject matter of example eight or any of the examples described herein, wherein the downstream comparison points and the upstream comparison points comprise the equivalent GL netlist logic influenced by the one or more fault nodes and correspond to the RTL logic to be replaced. Example fourteen may include the subject matter of example eight or any of the examples described herein, wherein the RTL logic for the hardware design is implemented using Verilogic.

In example fifteen a system comprises a processor to perform a hybrid Register Transfer Level (RTL)/gate-level (GL) fault injection simulation of a hardware design, and a memory coupled to the processor to store the hardware design, wherein the processor is to generate a list of one or more fault nodes in a GL netlist for the hardware design, map functionally equivalent comparison points between RTL logic for the hardware design and GL netlist of the hardware design, identify a nearest set of downstream comparison points for one or more logic paths for the one or more fault nodes, identify a nearest set of upstream comparison points for the one or more identified downstream comparison points, replace RTL logic with equivalent GL netlist logic to provide hybrid RTL/GL netlist in code, and perform fault injection simulating using the hybrid RTL/GL netlist code. Example sixteen may include the subject matter of example fifteen or any of the examples described herein, wherein the said mapping is performed using logic equivalency checking (LEC). Example seventeen may include the subject matter of example fifteen or any of the examples described herein, wherein a result of said mapping is stored in a one-to-one (1:1) database or a one-to-many (1:M) database. Example eighteen may include the subject matter of example fifteen or any of the examples described herein, wherein the downstream comparison points comprise fan-out nodes. Example nineteen may include the subject matter of example fifteen or any of the examples described herein, wherein the upstream comparison points comprise fan-in nodes. Example twenty may include the subject matter of example fifteen or any of the examples described herein, wherein the downstream comparison points and the upstream comparison points comprise the equivalent GL netlist logic influenced by the one or more fault nodes and correspond to the RTL logic to be replaced. Example twenty-one may include the subject matter of example eight or any of the examples described herein, wherein the RTL logic for the hardware design is implemented using Verilogic.

In various embodiments, the operations discussed herein, e.g., with reference to the figures described herein, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to the present figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A method to perform a hybrid Register Transfer Level (RTL)/gate-level (GL) fault injection simulation of a hardware design, comprising:
generating a list of one or more fault nodes in a GL netlist for the hardware design;
mapping functionally equivalent comparison points between RTL logic for the hardware design and GL netlist of the hardware design;
identifying a nearest set of downstream comparison points for one or more logic paths for the one or more fault nodes;
identifying a nearest set of upstream comparison points for the one or more identified downstream comparison points;
replacing RTL logic with equivalent GL netlist logic to provide hybrid RTL/GL netlist in code; and
performing fault injection simulating using the hybrid RTL/GL netlist code.

2. The method of claim 1, wherein the said mapping is performed using logic equivalency checking (LEC).

3. The method of claim 1, wherein a result of said mapping is stored in a one-to-one (1:1) database or a one-to-many (1:M) database.

4. The method of claim 1, wherein the downstream comparison points comprise fan-out nodes.

5. The method of claim 1, wherein the upstream comparison points comprise fan-in nodes.

6. The method of claim 1, wherein the downstream comparison points and the upstream comparison points comprise the equivalent GL netlist logic influenced by the one or more fault nodes and correspond to the RTL logic to be replaced.

7. The method of claim 1, wherein the RTL logic for the hardware design is implemented using Verilogic.

8. One or more non-transitory machine-readable media having instructions stored thereon that, when executed by a processor to perform a hybrid Register Transfer Level (RTL)/gate-level (GL) fault injection simulation of a hardware design, result in:
generating a list of one or more fault nodes in a GL netlist for the hardware design;
mapping functionally equivalent comparison points between RTL logic for the hardware design and GL netlist of the hardware design;
identifying a nearest set of downstream comparison points for one or more logic paths for the one or more fault nodes;
identifying a nearest set of upstream comparison points for the one or more identified downstream comparison points;
replacing RTL logic with equivalent GL netlist logic to provide hybrid RTL/GL netlist in code; and
performing fault injection simulating using the hybrid RTL/GL netlist code.

9. The one or more non-transitory machine-readable media of claim 8, wherein the said mapping is performed using logic equivalency checking (LEC).

10. The one or more non-transitory machine-readable media of claim 8, wherein a result of said mapping is stored in a one-to-one (1:1) database or a one-to-many (1:M) database.

11. The one or more non-transitory machine-readable media of claim 8, wherein the downstream comparison points comprise fan-out nodes.

12. The one or more non-transitory machine-readable media of claim 8, wherein the upstream comparison points comprise fan-in nodes.

13. The one or more non-transitory machine-readable media of claim 8, wherein the downstream comparison points and the upstream comparison points comprise the equivalent GL netlist logic influenced by the one or more fault nodes and correspond to the RTL logic to be replaced.

14. The one or more non-transitory machine-readable media of claim 8, wherein the RTL logic for the hardware design is implemented using Verilogic.

15. A system, comprising:
a processor to perform a hybrid Register Transfer Level (RTL)/gate-level (GL) fault injection simulation of a hardware design; and
a memory coupled to the processor to store the hardware design;
wherein the processor is to:
generate a list of one or more fault nodes in a GL netlist for the hardware design;
map functionally equivalent comparison points between RTL logic for the hardware design and GL netlist of the hardware design;
identify a nearest set of downstream comparison points for one or more logic paths for the one or more fault nodes;
identify a nearest set of upstream comparison points for the one or more identified downstream comparison points;
replace RTL logic with equivalent GL netlist logic to provide hybrid RTL/GL netlist in code; and
perform fault injection simulating using the hybrid RTL/GL netlist code.

16. The system of claim 15, wherein the said mapping is performed using logic equivalency checking (LEC).

17. The system of claim 15, wherein a result of said mapping is stored in a one-to-one (1:1) database or a one-to-many (1:M) database.

18. The system of claim 15, wherein the downstream comparison points comprise fan-out nodes.

19. The system of claim 15, wherein the upstream comparison points comprise fan-in nodes.

20. The system of claim 15, wherein the downstream comparison points and the upstream comparison points comprise the equivalent GL netlist logic influenced by the one or more fault nodes and correspond to the RTL logic to be replaced.
